(19) United States
(12) Patent Application Publication
(10) Pub. No.: US 2008/0053756 A1
(43) Pub. Date: Mar. 6, 2008

(54) ELEVATOR INSTALLATION WITH CAR AND COUNTERWEIGHT AND METHOD FOR ARRANGEMENT OF AN ELEVATOR INSTALLATION

(76) Inventor: Nicolas Gremaud, Wadenswil (CH)

Correspondence Address: FRASER CLEMENS MARTIN & MILLER LLC, 28366 KENSINGTON LANE, PERRYSBURG, OH, 43551, US

(21) Appl. No.: 11/848,673

(22) Filed: Aug. 31, 2007

(30) Foreign Application Priority Data
Aug. 31, 2006 (EP) 06119918.8.

(51) Int. Cl. B66B 7/00

(52) U.S. Cl. 187/276; 187/401; 187/406; 187/408; 187/411; 187/414

(57) ABSTRACT

An elevator installation includes a car and with a counterweight in an elevator shaft, the car and the counterweight being guided by two guide rails. The elevator shaft is bounded by shaft walls and shaft doors, which define a cross-section of the elevator installation. The invention the cross-section of the elevator installation is constructed in such a manner that it substantially corresponds with a sum of the cross-sectional area of the car, the cross-sectional area of the counterweight and the safety areas between the car and the wall, the counterweight and the wall, as well as the counterweight and the car. The cross-sectional area of the car is accordingly maximized and a transport area available for transport of persons or goods is correspondingly enlarged.

### FIELD OF THE INVENTION

The invention relates to an elevator installation with a car and with counterweight and to a method for arrangement of an elevator installation.

### BACKGROUND OF THE INVENTION

The elevator installation is installed in a shaft. It substantially consists of a car which is connected with a counterweight by way of support means. By means of a drive, which selectably acts on the support means or directly on the car or the counterweight, the car is moved along a substantially vertical car travel path and the counterweight is moved along a substantially vertical counterweight travel path.

An elevator installation in which a car travel path and the counterweight travel path are defined by a pair of or by means of two guide rails is known from published German specification DE 4423412. The shaft space can be better utilized.

### SUMMARY OF THE INVENTION

The present invention has an object of maximizing a cross-sectional area of the car and thus optimizing utilization of the cross-section in the building. Moreover, possibilities for an overall optimum space utilization of the elevator installation in a building shall be demonstrated. The elevator installation shall be able to be disposed or arranged in an optimum manner.

The elevator installation according to the present invention comprises a car and a counterweight in an elevator shaft, as well as two guide rails for guidance in common of car and counterweight. The elevator shaft is bounded by shaft walls and shaft doors. The shaft walls and at least one shaft door define a cross-section which is available for the elevator installation.

According to the present invention the cross-sectional area of the car is now maximized in that the total cross-section of the elevator installation with the exception of a cross-sectional area, which is required for the counterweight, and safety areas between the car and the wall or the shaft door, between the counterweight and the wall and between the counterweight and the car, can be used as cross-sectional area of the car. The advantage of this invention is that the cross-sectional area for the car is maximized and a car area, which is available for transport of goods or persons, can be executed to be as large as possible. On the one hand, through use of the common guide rail pair, which is known from DE 4423412, for guidance of car and counterweight a cross-sectional requirement for further individual guide rails is eliminated and, in addition, in particular no further cross-sectional areas for support means, shaft information apparatus or speed limiter cables are present. The guide rails used for guidance of counterweight and car are substantially arranged within the cross-section which is in any case required as safety cross-section between car and counterweight. Apart from the maximized cross-sectional utilization, an economic elevator installation results at the same time, since less material is used and assembly costs can be kept small.

Required safety areas are oriented towards different demands. On the one hand, safety standards such as, for example, the elevator standard EN81 define minimum spacings. Other standards define spacings for reducing risks of being caught. Moreover, these spacings take into consideration tolerances and non-planar surfaces caused by construction. These spacings are selected in dependence on the selected method of construction. Safety areas result through multiplication of these spacings by the corresponding width dimension or length dimension. Advantageously, a safety area between the car and the wall, as well as between the counterweight and the wall, corresponds with a safety spacing (SW) of less than 50 millimeters. A spacing of approximately 15 to 40 millimeters has proved ideal. A small spacing is selected for settable spacings such as, for example, in the region of the shaft doors and a comparatively large spacing is selected in the region of raw concrete walls, since greater non-planar relationships can result there. A required safety area between the counterweight and the car advantageously corresponds with a safety spacing (SKG) of approximately 50 millimeters. This spacing is recommended for reduction of a trapping effect if, for example, a service representative travels on the car for the purpose of servicing work. Obviously this spacing could also be reduced if, for example, other safety measures were provided which would prevent trapping when counterweight and car cross in the elevator shaft.

Advantageously the guide rail or each of the guide rails is a T-shaped guide rail with two guide webs and a fastening web, wherein a height of the guide rail or a height of the fastening web approximately corresponds with the thickness of the counterweight. A first guide web serves for guidance of the car and a second guide web serves for guidance of the counterweight. The fastening web is used for fastening the guide rail to a wall. Advantageously, the guide webs of car and counterweight are arranged in one plane. This plane at the same time forms the guide plane of counterweight and car. A rail executed in that manner is of compact construction and it thereby demands little space. It can be arranged in the regions of the safety surface or of the spacing (SKG).

In a variant of embodiment the guide web used for guidance of the car has a higher strength by comparison with the guide web used for guidance of the counterweight. This is advantageous insofar as the guide web at the car side can experience a comparatively higher loading. The guide rail can thus be adapted in optimum manner to the anticipated loads.

In a particularly efficient embodiment a guide plane, which is defined by the guide webs, of the counterweight is arranged to be laterally offset relative to a gravitational force line of the counterweight. The guide web at the counterweight side can, in this connection, be arranged near the car. This allows construction of a stiff guide rail, since the fastening web can be constructed to be appropriately high and stiff.

Advantageously the elevator car is equipped with car brakes, which are controlled in drive by way of electrical means and the drive control of which does not require any additional cross-section in the elevator shaft. A cross-sectional requirement for arrangement of a speed limiter cable can accordingly be eliminated. Moreover, a car brake electrically controlled in drive in that manner can be used so as to improve overall a space utilization of the elevator installation in the building. Thus, this car brake can be used for the purpose of equipping a protective space below or above the car when this is required for the purpose of maintenance. Since this car brake in the case of need can also generate substantial braking forces in upward direction the use thereof for equipping the temporary protective space is also possible in upward direction. Equally, a buffer at the shaft end can be almost completely eliminated by means of a car brake of that kind, since by way of the electrical drive control and associated state sensors a faulty behavior of the elevator installation can be detected in good time before reaching an end stopping point.

In an embodiment by way of example the drive control of the car brakes is carried out by way of speed monitoring means which ascertain and monitor a travel speed of the car with respect to a guide rail or the elevator shaft or a wall of the elevator shaft. This can be affected by means of a tachometer which runs along the guide rail, a magnetically coded strip mounted on the guide rail can be used or optical systems can be used in order to ascertain the speed. Advantageously, use is made of a sensor which at the same time contains information with respect to the position of the car in the shaft. A positionally dependent braking can thereby be carried out and as a result thereof rapid braking actions can be performed in the regions of the shaft ends or a temporary protective space can be provided.

The car and the counterweight are connected together by way of support means, wherein the support means are respectively mounted at the car at the top and at the counterweight at the bottom. Vertical sections of the support means are arranged within the projections of the car and the counterweight cross-sectional areas. This is advantageous, since the support means do not require any further cross-sectional area in the elevator shaft. In addition, a constructional space requirement below the car can be executed to be minimal. This allows good utilization of the building space.

The support means is advantageously fastened to the car or the counterweight by means of a deflecting roller, wherein the deflecting roller is arranged within the cross-sectional area of the car or within the cross-sectional area of the counterweight. Moreover, the support means is arranged in such a manner that the car and preferably also the counterweight are suspended substantially centrally. This is advantageous, since small, space-saving drives can thereby be used. In addition, by virtue of the central suspension the guide rail is substantially relieved of bending forces in normal operation, a good travel comfort thereby being possible. Moreover, through the use of a regulated car brake a loading of the rails can be kept small even in the case of emergency braking. This allows the use of more advantageous guide rails.

The support means is connected at its end, which is at the car side, directly with a ceiling of the shaft or with a support beam. Use of a support beam allows the use of more favorable fastening means and imposes low demands on the construction of the shaft. Thereagainst, a direct connection with the ceiling of the shaft requires few components.

Advantageously the deflecting rollers at the car side are integrated in an edge region of a car ceiling and the support beam crosses the car ceiling along a car ceiling lower surface. By means of this efficient construction it is possible to provide a standing area, which is arranged in the center region of the car ceiling, and edge regions of the ceiling at the same time serve as a boundary pedestal. An upper protective space is thereby not impaired by the deflecting rollers.

In one embodiment by way of example, the car has a car space and at least one car access region and the guide rails and the counterweight are arranged in a region laterally of the car access region, wherein the counterweight together with the guide rails has a width which substantially corresponds with a side dimension (TKR) of the car space and the counterweight has a thickness (TG) which substantially corresponds with a lateral projection (UT), which is required for opening the car access, of the car access space with subtraction of the safety spacing (SKG) between car and counterweight. Alternatively, the car rails and the counterweight are arranged in a region opposite the car access region, wherein the counterweight together with the guide rails has a width which substantially corresponds with a width dimension (BK) of the car space, or the guide rails and the counterweight are arranged in a region laterally of the car access space, wherein the counterweight together with the guide rails has a width which substantially corresponds with a side dimension (TK) of the car. This is advantageous if the width of the car access space is small or equal to the width (BK) of the car space. The illustrated possibilities allow a selection, which is optimized with respect to the building, of the suitable form of access. In addition, by combination of these variants of embodiment it is possible to create elevator installations with several car accesses.

Advantageously, further shaft apparatus such as shaft lighting, shaft information parts and shaft cabling are arranged in such a manner that safety spacings (SW, SKG) between the car and the wall, the counterweight and the wall as well as the counterweight and the car are not affected and a hanging cable for supply of the car with electrical energy and/or signals is arranged in the region of the car access space. Particularly advantageous is an arrangement of these parts, insofar as actually required, in corner zones of the shaft, since in this connection such a corner region can be used without influencing the safety spacing, or an arrangement of these parts is carried out in the region of a shaft door, since a shaft door has post regions or frame regions which are usable for arrangement of lighting, cables or sensors.

In an embodiment by way of example the counterweight has a thickness of at most 100 millimeters. This allows the arrangement of a typical counterweight deflecting roller above the counterweight.

The illustrated invention enables an optimum utilization of the building space, since it is shown by this how subassemblies of an elevator installation can be arranged or disposed in optimum manner.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic cross-section of an elevator installation according to the present invention;

FIG. 2 is an enlarged detail of the guide rail arrangement shown in FIG. 1;

FIG. 3 is a schematic elevation view of the elevator installation of FIG. 1 in maintenance operation;

FIG. 4 is a plan view of the elevator installation according to FIG. 3;

FIG. 5 is a schematic view of the elevator installation of FIG. 1 in normal operation;

FIG. 6 is an alternative arrangement of the support means according to the present invention;

FIG. 7 is a schematic view of an embodiment of the elevator installation according to the present invention with a counterweight arranged laterally of the car access;

FIG. 8 is a schematic view of a second embodiment of the elevator installation according to the present invention with a counterweight arranged laterally of two accesses of the car;

FIG. 9 is a schematic view of a third embodiment of the elevator installation according to the present invention with a counterweight arranged opposite the elevator access; and

FIG. 10 shows an arrangement of further shaft apparatus of the elevator installation according to the present invention.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Components which are identical and similar or have equivalent effect are provided in all figures with the same reference numerals.

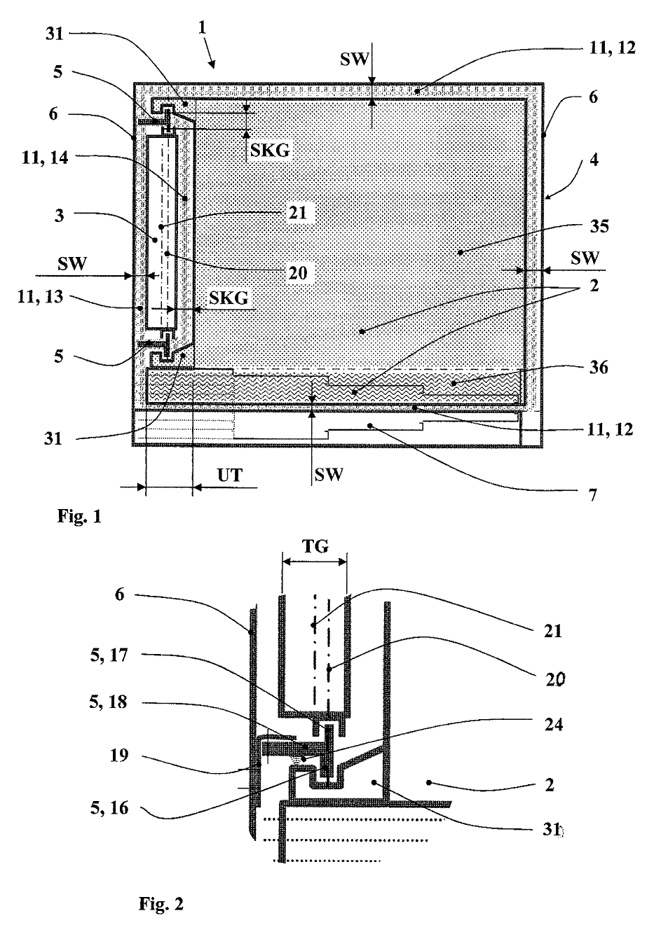

FIG. 1 shows a cross-section of an elevator installation 1 with a car 2 and with a counterweight 3 in an elevator shaft 4, as well as two guide rails 5 for guidance of the car 2 and the counterweight 3. Each of the two guide rails 5 forms a guidance region for guidance of the car 2 and a further guidance region for guidance of the counterweight 3. The counterweight 3 occupies an associated cross-sectional area which corresponds with the cross-section or a vertical projection of the counterweight 3. In addition, the car 2 occupies an associated cross-sectional area. In this connection the cross-sectional area of the car 2 corresponds with a vertical projection area of this car. The cross-sectional area of the car 2 contains, in this connection, in particular a car space region 35 which is defined substantially by a transport area for the reception of persons or goods and surrounding car walls, as well as support structures 31 and at least one car access region 36. The car 2 and the counterweight 3 are enclosed by the elevator shaft 4. In this connection, the elevator shaft 4 is bounded by shaft walls 6 and shaft doors 7 which at the same time define a cross-section of the elevator installation 1. The car 2 moves at a safety spacing (SW) along the walls 6 and the shaft door 7. In addition, the car 2 has a safety spacing (SKG) from the counterweight 3 and the counterweight 3 is arranged at a safety spacing (SW) from the wall of the elevator shaft 4.

The safety spacings (SW, SKG) are required so as to enable a collision-free movement of the car 2, so as to accept tolerances of elevator material or in the shaft 4, or otherwise to prevent trapping of hands, for example of service personnel. These safety spacings (SW, SKG) define, together with corresponding lateral dimensions, safety areas 11.

According to the present invention the cross-section of the elevator installation 1 substantially corresponds, as illustrated in FIG. 1 by way of example, with a sum of the cross-sectional area of the car 2, the cross-sectional area of the counterweight 3 and the safety areas 11, 12 between the car 2 and the walls 6, the safety area 11, 13 between the counterweight 3 and the wall 6 as well as the safety area 11, 14 between the counterweight 3 and the car 2. The cross-section of the elevator installation 1 is utilized in an optimum manner. The car 2 occupies a maximum possible proportion of the cross-section.

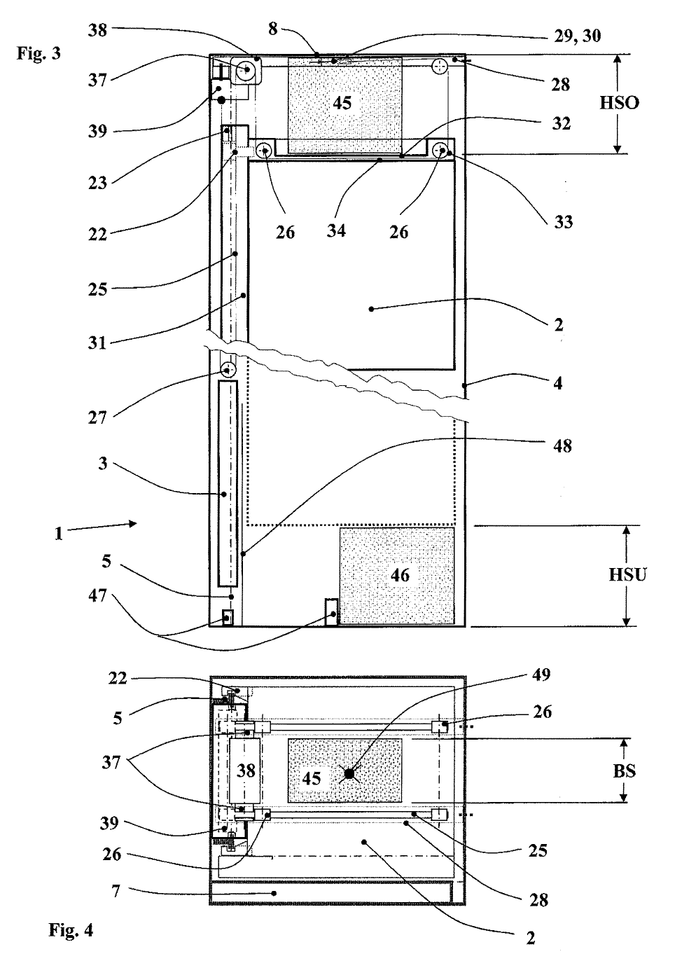

In the illustrated example according to FIG. 1 the safety spacing (SW) in the region of the walls is selected at approximately forty millimeters. Thus, compensation can be provided for usual building tolerances and non-planar areas of the shaft walls. Depending on the form of construction of the walls, the safety spacing (SW) can be reduced to as little as fifteen millimeters. This safety spacing is selected in the present example in the region of the shaft door 7, since this shaft door 7 can be precisely aligned. It is conceivable that the safety spacing in the region of the shaft door could even be reduced to approximately eight millimeters if, for example, very firm guidance systems are used. The safety spacing (SKG) between the car 2 and the counterweight 3 is selected at approximately fifty millimeters. This distance is proposed in standards and prevents, for example, trapping of hands if a service expert is located on the car in maintenance operation. The safety spacing (SKG) could also be reduced with use of additional safety precautions such as, for example, a safety barrier in the region of the car or the car ceiling. However, it is to be noted that a safety barrier 48 (as apparent in FIG. 3) between the car and the counterweight is often arranged in the region of a lower end of the elevator shaft. The safety spacing (SKG) has to take this into consideration. In order to reduce this safety spacing electronic safety barriers 48 would be required, or a safety barrier 48 which is arranged merely during the presence of a service person in the shaft.

The guide rail 5, as illustrated in FIG. 2, a T-shaped guide rail with two guide webs 16, 17 and a fastening web 18 and the height of the guide rail 5 or a height of the fastening web 18 approximately corresponds with a thickness (TG) of the counterweight 3. As apparent in FIG. 2, advantageously a guide plane 20 of the counterweight 3 is arranged to be laterally offset with respect to a gravitational force line 21 of the counterweight 3. This has the advantage that the fastening web 18 can be selected to be high, which gives an increased strength and stiffness of the guide rail 5. At the same time the car structure 31 can significantly embrace the guide web 16, which enables provision of the structure 31 with high strength. Moreover, it is additionally possible to mount in the region of the fastening web 18 a coding which enables a sensor 24, which is mounted at the car 2 or the car structure 31, to detect a travel speed and/or a travel position in the shaft. Thus, it is possible to dispense with the arrangement of a conventional speed limiter with an associated speed limiter cable. In this example of embodiment the guide rail 5 is fastened by means of a fastening bracket 19 to the same section of the shaft wall 6.

In the illustrated example the first guide web 16 of the guide rail 5 is used for guidance of the car 2 and the second guide web 17 of the guide rail 5 is used for guidance of the counterweight 3. The first and the second guide webs 16, 17 are substantially arranged in one plane, i.e. the guide plane 20. At the same time, in the example according to FIG. 2 the guide web 16 at the car side is thicker, i.e. executed with a higher strength, than the guide web 17 at the counterweight side. Obviously variations are possible here. Thus, the guide webs 16, 17 can also be arranged on different planes. This makes possible, in particular, an efficient matching of the car structure 31 and the guide 5 to one another.

Advantageously, as apparent in FIG. 1, the two guide rails 5 are fastened at the same shaft wall 6. This reduces the number of interface regions relative to the building.

The car 2 is, as apparent in FIG. 3, connected with the counterweight 3 by way of a support means 25. The support means 25 is mounted on the car 2 at the top and on the counterweight 3 at the top and vertical sections of the support means 25 run within the projections of car and counterweight cross-sectional areas. In the illustrated example, the car 2 and the counterweight 3 have a 2:1 suspension. The support means 25 is mounted by its end, which is at the car side, on a ceiling 8 of the elevator shaft 4. For this purpose support beams 28 which enable fastening of the support means 25 are arranged in the region of the shaft ceiling 8. The support means 25 extends from the shaft ceiling 8 or the support beams 28 to the car 2 or to a car ceiling 32. The support means 25 is deflected by means of deflecting rollers 26 at the car side and runs back into the region of the shaft ceiling 8, is guided there over a drive pulley 37 and runs back to a deflecting roller 27 at the counterweight side and is led from there again to the shaft ceiling. The drive pulley 37 drives and supports the support means 25 and thus the car 2 and the counterweight 3. The drive pulley 37 is driven by a drive 38. The drive 38 and the drive pulley 37 are arranged near the shaft ceiling 8 by means of a drive support 39. The drive support 39 is also used, in the example, as a coupling point of the end of the support means 25 at the counterweight side.

Usually, as apparent in FIG. 4, at least two support means 25 are used. In the illustrated example the two support means 25 are arranged at a spacing from one another. The spacing is selected in such a manner that an upper protective space 45 (FIG. 3) can be arranged between the support means 25. The upper protective space 45 is required so that a service engineer during his work in the region of the car roof always has available a minimum space. The deflecting rollers 26 as well as the drive pulleys 37 are also arranged in correspondence with the spacing of the support means 25. The drive 38 for driving the drive pulleys 37 is, in this example, arranged between the drive pulleys 37. Advantageously, the support beams 28 are similarly arranged in correspondence with the spacing of the support means 25. With this arrangement the end of the support means 25 at the car side can be deflected in the support beam 28 into a horizontal position and a support means lock 29 as well as required fastenings 30 can be arranged in the support beam 28. This is space-saving, since only a small vertical installation space is needed. In addition, the protective space 45 can now similarly be arranged between the support beams 28 as well as between the support means 25, which cross the car ceiling 32 along a car ceiling lower surface 34. The illustrated arrangement allows utilization of the shaft cross-section in optimum manner, since no cross-section for arrangement of the support means 25 is required and this arrangement demands little space above the car, since the protective space 45 is arranged between the support means 25 and the fastening structures thereof. As illustrated in FIG. 3, the deflecting rollers 26 are arranged in an edge region 33 of the car ceiling 32. The edge region is thereby increased and this increase at the same time forms a pedestal for preventing walking over the car roof edge.

The support means 25 are substantially (apart from loading, asymmetrical car fitments and car access influences) centrally arranged, i.e. a vertical gravitational force axis 49 of the car lies approximately in a resultant load-bearing force line defined by the support means 25 acting on the car 2. The guide rails 5 and guide shoes 23, which in normal operation guide the car along the guide rails 5, are thereby loaded only insignificantly. This allows the use of lighter guide rails 5 and lighter guide shoes 23.

The elevator car is, as illustrated in FIG. 3, equipped with a car brake 22 or a corresponding blocking device. The car brake 22 is arranged in the upper region of the car structure 31 and is in a position of holding and/or braking the car in every operational position. The car structure 31 with the installed car brake 32 is disposed, in projection, outside the projection of the drive support 39 and the drive 38. Parts of the car structure 31 with car brake 22 can thus travel past the drive 38 at least in part. The car brake 22 is controlled in drive by electrical means and it can be controlled in drive, for example in the case of maintenance operation, by means the sensor 24 (FIG. 2) or other safety apparatus in such a manner that the upper protective space 45, corresponding with an upper safety spacing (HSO), as well as also a lower protective space 46, corresponding with a lower safety spacing (HSU), are safely guaranteed. This car brake 22 makes it possible for no further cross-sectional area, for example for arrangement of a speed limiter cable, to be required. The cross-section of the elevator installation 1 is optimally utilized or a cross-sectional area of the car 2 is maximized.

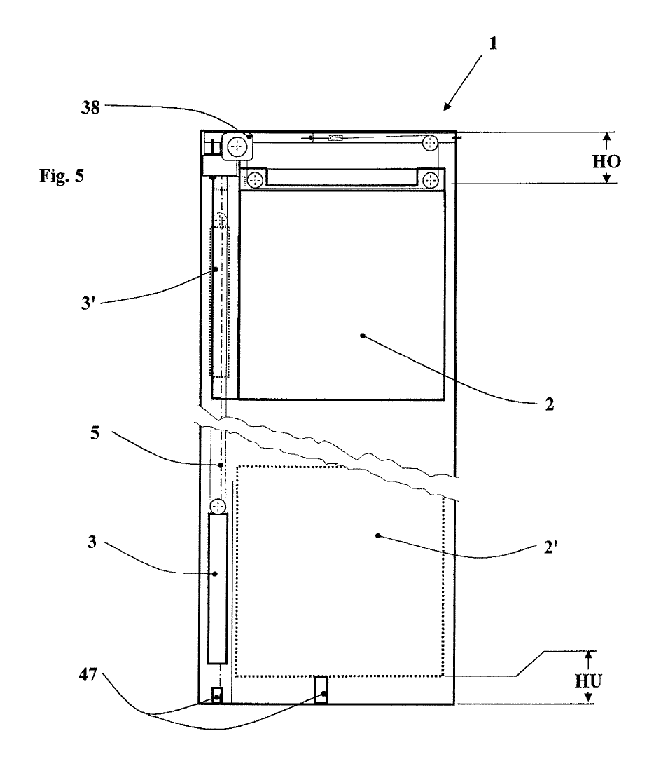

The elevator installation illustrated in FIG. 3 is disposed in a service setting, i.e. the upper and the lower protective spaces 45, 46 are guaranteed by the car brake 22 in that the brake control with use of the data of the sensor 24 prevents movement into the protective spaces 45, 46. FIG. 5 shows the same installation in a normal operating state. Safety means (not illustrated) prevent a person from being located below or above the car in the normal operating state. The car can now utilize the entire travel path. It is merely necessary to consider operating spacings (HO, HU) which prevent collision of parts. It is conceivable that the car 2 could be moved up to the spacing (HO) of approximately two hundred millimeters from the shaft ceiling 8. This is possible particularly because parts of the car structure 31 with the car brake 22 and the guide shoe 23 can travel partly past the drive 38. Similarly, very small operating spacings are now realized in the lower region of the shaft. All parts serving for movement of the car, such as deflecting rollers, brakes and guide shoes, are located in the upper region of the car or laterally thereof (lower guide shoes). The car 2′ can thus in normal operation be moved very far downwardly so that the lower operating spacing (HU) can approximately approach zero. A construction of that kind is very advantageous, since accordingly no special shaft pits or shaft pit depressions have to be provided. A shaft end buffer 47 could, if required, be completely eliminated or be replaced by end abutments which can similarly be integrated in the thickness of a car floor.

The counterweight 3 is, as illustrated in FIG. 5, less high than the height of the car 2. Compensation for a support means elongation of the support means 25 can thereby be provided in simple manner, since the counterweight 3 includes appropriate travel reserves in its travel path 3, 3′.

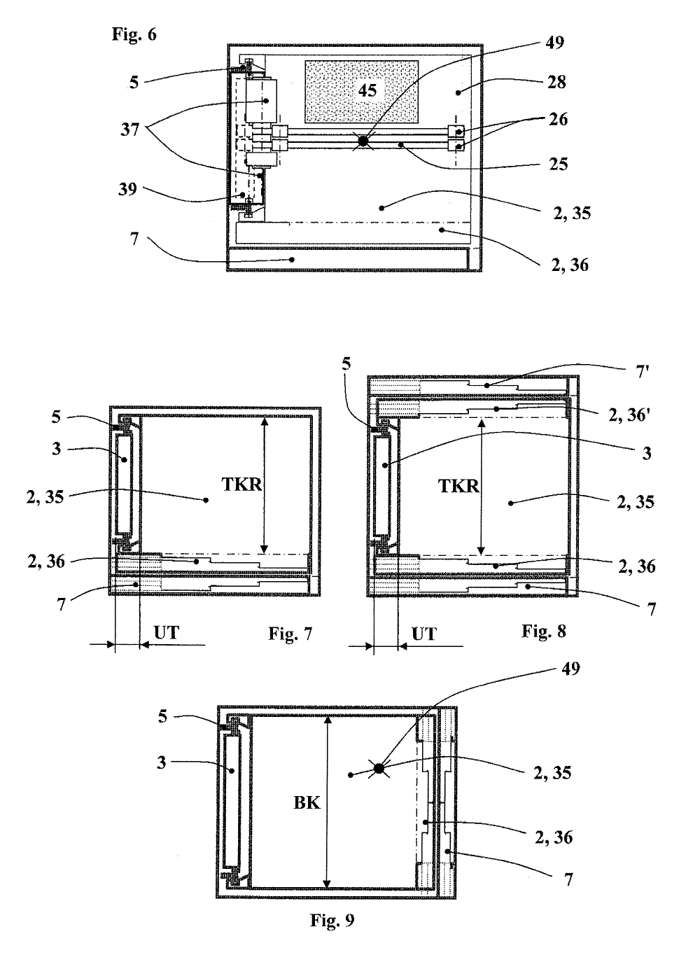

FIG. 6 shows an alternative embodiment of a suspension. The support means 25 are guided closely adjacent to one another and the resulting load-bearing force line lies approximately on the vertical gravitational force line 49 of the car 2. The protective space 45 is arranged, in the illustrated example, in the rear region of the car 2. The support beam 28 extends parallel to and in the vicinity of the shaft wall 6.

The elevator installation according to FIG. 7 with the car 2 and the car space 35 has a single shaft access region 36. The guide rails 5 and the counterweight 3 are arranged in a region laterally of this car access region 36. The counterweight 3 has, together with the guide rails 5, a width which substantially corresponds with a side dimension (TKR) of the car space 35 and the counterweight 3 has a thickness (TG) which substantially corresponds with a lateral projection (UT), which is required for opening the car access, of the car access space 36 less the safety spacing (SKG) between the car 2 and the counterweight 3 (TG=UT−SKG). In this connection it is to be noted that possible door regions which, during travel of the car 2, are disposed in a pushed-together (closed) state can penetrate during opening of the door, at a stop, entirely into the region of the safety spacing (SW) between the car and the wall. This is possible, since the car 2 is not moved in this state.

FIG. 8 shows an elevator installation as previously described, wherein two mutually opposite car access regions 36, 36′ are used.

FIG. 9 shows a further arrangement possibility of the car access region 36 in which the guide rails 5 and counterweight 3 are arranged in a region opposite the car access region 36, wherein the car 2 together with the guide rails 5 has a width which substantially corresponds with a width dimension BK of the car space 35.

The guide rails 5 and the counterweight 3 can obviously be arranged in a region laterally of the car space and the counterweight can, together with the guide rails 5, have a width which substantially corresponds with a side dimension (TK) of the car. This is useful if the car access region 36 is equal to the width (BK) of the car.

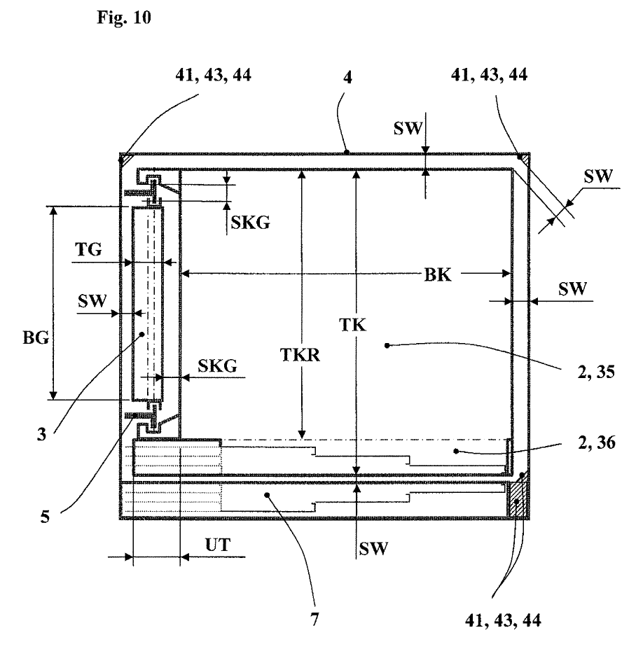

The elevator installation as a rule contains further shaft apparatus which usually require an enlargement of the cross-section of the elevator installation 1. These are, for example, a shaft lighting 41, shaft information parts 43, shaft cabling or hanging cable 44. FIG. 10 shows shaft apparatus 41, 43, 44 of that kind in an elevator installation according to the present invention without the cross-sectional area thereof having to be enlarged. The shaft apparatus 41, 43, 44 are arranged in such a manner that safety spacings between the car and the wall (SW), the counterweight and the wall (SW) as well as the counterweight and the car (SKG) are not affected. The hanging cable 44 for supply of the car with electrical energy and/or signals is, in the illustrated example, arranged in the region of the car/shaft access 36, 7. The shaft lighting 41 is arranged in the region of the access at the shaft side, for example accommodated in the door post at the closure side, and the shaft cable 44 or the information transmitter 42 is arranged in a corner region of the shaft. The regions for arrangement of these apparatus are, in principle, exchangeable. It is obvious that also wireless transmission means can be used for transmission of energy or signals or from case to case apparatus can be arranged in the region of the guide rail or integrated in the rail itself.

A drive control unit or drive parts, such as a converter or an emergency control apparatus, is or are advantageously arranged in a region above an uppermost opening region of the car access space, or arranged in a region of an access, which is at the floor side, to the car or of a door frame region belonging to this access at the floor side.

With knowledge of the present invention the elevator expert can change and combine the set shapes and arrangements as desired. For example, a elevator installation with three car access regions can also be created in that the arrangement shown in FIG. 8 is combined with the arrangement according to FIG. 9 or a drive control for equipping the protective space 46, as explained in conjunction with FIG. 3, can be simultaneously used in order to furnish the temporary safety barrier 48 in the region of the lower shaft end. In addition, the shaft wall is usually solid masonry. It is obvious that the shaft wall or parts thereof can also be of glass or also designed to be open.

The invention is just as suitable for optimization of new elevator installations as for modernization of elevator installations, wherein, especially in the case of modernizations, a transport capacity can be increased by maximization of the cross-sectional area of the car.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator installation with a car and a counterweight in an elevator shaft, two guide rails for guiding the car and the counterweight, which elevator shaft is bounded by shaft walls and shaft doors, which define a cross-section of the elevator installation, comprising: the cross-section of the elevator installation substantially corresponds with a sum of a cross-sectional area of the car, a cross-sectional area of the counterweight and cross-sectional areas of safety areas between the car and adjacent ones of the walls, the counterweight and an adjacent one of the walls, and the counterweight and the car.

2. The elevator installation according to claim 1 wherein said safety areas between the car and adjacent ones of the walls as well as said safety area between the counterweight and an adjacent one of the walls correspond with a safety spacing in a range of 50 millimeters to 15 millimeters, and said safety area between the counterweight and the car corresponds with a safety spacing of approximately 50 millimeters.

3. The elevator installation according to claim 1 wherein each of the guide rails is a T-shaped guide rail with two guide webs and a fastening web, and a height of the guide rail or a height of said fastening web approximately corresponds with a thickness of the counterweight.

4. The elevator installation according to claim 1 wherein each of the guide rails has a first guide web for guidance of the car and a second guide web for guidance of the counterweight and said first and second guide webs are arranged substantially in a common guide plane.

5. The elevator installation according to claim 1 wherein each of the guide rails has a first guide web for guidance of the car and a second guide web for guidance of the counterweight and said first guide web has a higher strength than said second guide web.

6. The elevator installation according to claim 1 wherein each of the guide rails has a guide web for guidance of the counterweight and said guide webs extend in a guide plane which is laterally offset relative to a gravitational force line of the counterweight.

7. The elevator installation according to claim 1 wherein the elevator car is equipped with car brakes with a drive control that does not require any additional cross-section area in the elevator shaft.

8. The elevator installation according to claim 7 wherein said drive control includes a speed monitoring means which ascertains and monitors a travel speed of the car with respect to one of the guide rails or the elevator shaft.

9. The elevator installation according to claim 1 wherein the car and the counterweight are connected by support means, said support means mounted respectively at a top of the car and at a top of the counterweight, wherein vertical sections of said support means are arranged within vertical projections of the car and the counterweight cross-sectional areas.

10. The elevator installation according to claim 9 wherein said support means is fastened to the car or to the counterweight by deflecting rollers arranged within the cross-sectional area of the car or within the cross-sectional area of the counterweight respectively, and said support means suspends the car and the counterweight centrally.

11. The elevator installation according to claim 1 wherein the car and the counterweight are connected by support means, said support means being connected at an end associated with the car directly with a ceiling of the elevator shaft or with a support beam.

12. The elevator installation according to claim 1 wherein the car and the counterweight are connected by support means and including deflecting rollers integrated in an edge region of a car ceiling and said support means crossing said car ceiling along a car ceiling lower surface.

13. The elevator installation according to claim 1 wherein the car has a car space and at least one car access region and the guide rails and the counterweight are arranged in a region laterally of said car access region, wherein the counterweight together with the guide rails have a width corresponding with a side dimension of said car space and the counterweight has a thickness, corresponding with a lateral protrusion of said car access region that is required for opening said car access region to said car space, less a safety distance between the car and the counterweight.

14. The elevator installation according to claim 1 wherein the car has a car space and a car access region and the guide rails and the counterweight are arranged in a region opposite the car access region, wherein the counterweight together with the guide rails have a width corresponding with a width of the car space.

15. The elevator installation according to claim 1 wherein the car has a car space and a car access region and the guide rails and the counterweight are arranged in a region laterally of the car access region, wherein the counterweight together with the guide rails have a width corresponding with a side dimension of the car.

16. The elevator installation according to claim 1 including a drive arranged in one of a region above an uppermost opening region of a car access region, a region of said car access region at a floor side, and a door frame region of said car access region at the floor side.

17. The elevator installation according to claim 1 including shaft apparatus arranged in the elevator shaft whereby safety spacings between the car and adjacent ones of the walls, the counterweight and an adjacent one of the walls, and the counterweight and the car are not reduced.

18. The elevator installation according to claim 17 wherein said shaft apparatus includes at least one of shaft lighting, shaft information parts, shaft cabling, and a hanging cable for supply of the car with at least one of electrical energy and signals arranged in a shaft access space of the car.

19. The elevator installation according to claim 1 wherein the counterweight has a thickness that does not exceed 100 millimeters.

20. A method for arrangement of an elevator installation with a car and a counterweight in an elevator shaft with walls, and two guide rails for guidance of the car and the counterweight, comprising the steps of:
a. providing the elevator car with a first predetermined cross-sectional area;
b. providing the counterweight with a second predetermined cross-sectional area; and
c. providing the elevator shaft with a third predetermined cross-sectional area whereby said third predetermined cross-sectional area is minimized to correspond with a sum of said first cross-sectional area of the car, said second cross-sectional area of the counterweight and cross-sectional areas of safety areas between the car and adjacent ones of the walls, the counterweight and an adjacent one of the walls, and the counterweight and the car.
